(19) United States
(12) Patent Application Publication
(10) Pub. No.: US 2023/0362161 A1
(43) Pub. Date: Nov. 9, 2023

(54) SYSTEMS AND METHODS FOR SECURE DELEGATED ACCESS TO DIGITAL RESOURCES

(71) Applicant: JPMORGAN CHASE BANK, N.A., New York, NY (US)

(72) Inventors: Howard SPECTOR, Street, MD (US); Tayo IBIKUNLE, Haverford, PA (US); Ryan EAVY, Chicago, IL (US); Ryan S YODER, Tampa, FL (US); Srividya RAJESH, Plano, TX (US); Hermann LUECKHOFF, Sunny vale, CA (US); Paul SIMON, New York, NY (US)

(21) Appl. No.: 17/662,463

(22) Filed: May 9, 2022

(51) Int. Cl. H04L 9/40

(52) U.S. Cl. CPC H04L 63/0884; H04L 63/108; H04L 63/101

(57) ABSTRACT

Systems and methods for providing secure access to delegated resources are disclosed. In accordance with embodiments, a method may include receiving a delegation request, where the delegation request is associated with a user account; determining a list of delegable resources for which the user account has permission to delegate access; presenting the list of delegable resources via a user interface; receiving from the user interface, a user selection of a delegable resource from the list; generating a delegate identifier; associating an access permission to the delegate identifier, where the access permission provides access to the delegable resource; receiving the delegate identifier via the user interface; authenticating the delegate identifier; and providing access to the delegable resource based on the access permission.

### BACKGROUND

### 1. Field of the Invention

Aspects are generally related to systems and methods for secure delegated resource access.

### 2. Description of the Related Art

Access considerations with respect to digital resources have many important risk implications, such as security, privacy, and fraud prevention. Restricted access to resources can mitigate some risk factors, but restriction comes with tradeoffs in flexibility and productivity. Often, an owner, manager, primary user, etc., of a digital resource or service desires or needs to delegate access to the resource, but lacks a secure, organization-authorized, and/or well-defined way to do so. As a result, users may resort to insecure and unauthorized self-help procedures, such as sharing of user credentials for sensitive resources, in order to delegate access. Such practices introduce risk to organizations that can be largely mitigated with secure procedures for access delegation.

### SUMMARY

In some aspects, the techniques described herein relate to a system for providing secure delegated access to a digital resource, including: an authentication module; a user directory; as access control module; a delegation services module; and a user interface; wherein the delegation services module is configured to: receive, from the user interface, a delegation request, and wherein the delegation request is associated with a user account stored in the user directory; invoke the access control module to determine a list of delegable resources for which the user account has permission to delegate access; present the list of delegable resources via a user interface; receive from the user interface, a user selection of a delegable resource from the list; and generate a delegate identifier; wherein the access control module is configured to associate an access permission to the delegate identifier, wherein the access permission provides access to the delegable resource; wherein the authentication module is configured to receive the delegate identifier via the user interface; and authenticate the delegate identifier; and wherein the access control module is further configured to provide access to the delegable resource based on the access permission.

In some aspects, the techniques described herein relate to a system, wherein the delegation request includes the access permission.

In some aspects, the techniques described herein relate to a system, wherein the access permission is a default permission.

In some aspects, the techniques described herein relate to a system, wherein the delegation request incudes an electronic communication method.

In some aspects, the techniques described herein relate to a system, wherein the delegation services module is further configured to send a communication via the electronic communication method, and wherein the communication includes the delegate identifier.

In some aspects, the techniques described herein relate to a system, wherein the access permission is a use-bound permission.

In some aspects, the techniques described herein relate to a system, wherein the access permission is a time-bound permission.

In some aspects, the techniques described herein relate to a system, wherein the access control module employs an attribute-based access control scheme.

In some aspects, the techniques described herein relate to a system, wherein the delegable resource is a vehicle operation resource.

In some aspects, the techniques described herein relate to a system, wherein the user interface is included as a physical interface of the vehicle.

In some aspects, the techniques described herein relate to a method of providing secure delegated access to a digital resource, including: receiving a delegation request, wherein the delegation request is associated with a user account; determining a list of delegable resources for which the user account has permission to delegate access; presenting the list of delegable resources via a user interface; receiving from the user interface, a user selection of a delegable resource from the list; generating a delegate identifier; associating an access permission to the delegate identifier, wherein the access permission provides access to the delegable resource; receiving the delegate identifier via the user interface; authenticating the delegate identifier; and providing access to the delegable resource based on the access permission.

In some aspects, the techniques described herein relate to a method, wherein the delegation request includes the access permission.

In some aspects, the techniques described herein relate to a method, wherein the access permission is a default permission.

In some aspects, the techniques described herein relate to a method, wherein the delegation request incudes an electronic communication method.

In some aspects, the techniques described herein relate to a method, including: sending a communication via the electronic communication method, and wherein the communication includes the delegate identifier.

In some aspects, the techniques described herein relate to a method, wherein the access permission is a use-bound permission.

In some aspects, the techniques described herein relate to a method, wherein the access permission is a time-bound permission.

In some aspects, the techniques described herein relate to a method, including: employing an attribute-based access control scheme.

In some aspects, the techniques described herein relate to a method, wherein the delegable resource is a vehicle operation resource.

In some aspects, the techniques described herein relate to a non-transitory computer readable storage medium, including instructions stored thereon for providing secure delegated access to a digital resource, which when read and executed by one or more computers cause the one or more computers to perform steps comprising: receiving a delegation request, wherein the delegation request is associated with a user account; determining a list of delegable resources for which the user account has permission to delegate access; presenting the list of delegable resources via a user interface; receiving from the user interface, a user selection of a delegable resource from the list; generating a delegate identifier; associating an access permission to the delegate identifier, wherein the access permission provides access to the delegable resource; receiving the delegate identifier via the user interface; authenticating the delegate identifier; and providing access to the delegable resource based on the access permission.

### BRIEF DESCRIPTION OF THE DRAWINGS

FIG. 1 is a block diagram of a system for providing secure delegated access to a digital resource, in accordance with aspects.

FIG. 2 is a logical flow for providing secure delegated access to a digital resource, in accordance with aspects.

FIG. 3 is a logical flow for providing secure delegated access to a digital resource, in accordance with aspects.

### DETAILED DESCRIPTION OF ASPECTS

Aspects are generally related to systems and methods for secure delegated digital resource access.

In accordance with aspects, an authentication module and an access control module and a delegation services module can be configured to provide secure, delegated access to digital resources. An organization's technology infrastructure can house and provide digital resources. Resources can be provided as digital services and/or digital artifacts for use by authenticated users. A user that wishes to delegate authority and access to another is referred to herein as a “requesting user.” The user to whom the requesting user wishes to delegate access to is referred to herein as a “delegated user.”

A requesting user can authenticate via a user interface to an organization's authentication services. The organization's authentication services can be hosted and provided as part of the organization's technology infrastructure. As part of an authentication service, an organization can maintain a user directory. A user directory can include a database of users that have been authorized to access digital resources provided by an organization. A user may be represented in a use directory by a corresponding user account. The user account can include details about the corresponding user, such as name, address, phone number, etc. A user directory may also store ownership details and access details (e.g., permissions) to digital resources that are associated with the user accounts stored therein.

An organization can provide services such as an authentication module that is in operative communication with a user directory. An authentication module can be configured to receive authentication requests and process the requests against a user directory. Authentication requests can include a user identification and challenge information (collectively referred to as “user credentials”). The challenge information can correspond to a challenge criterium that authenticates the provider of the challenge information as the user associated with the corresponding user account.

An exemplary authentication scheme includes a username as the user identification and a password as the challenge information. A user associated with a user account stored in an organization's user directory can provide a username and a password to an authentication module. The authentication module can look up the username in the user directory. If the username is found, the authentication module can compare the user-provided password with a password associated with the user account. If the passwords match, the challenge to the user's identity is considered overcome, and the user is authenticated.

Other exemplary user identifiers can be device-based, such as recognition of a unique device identifier of a device with which a user is accessing a system with/from (sometimes referred to as a “trusted device”). Other exemplary challenge information can include biometric information (i.e., a fingerprint scan, a retinal scan, etc.). Dual factor authentication requests challenge information from two separate sources, e.g., a password from a browser client and an authentication code provided to an email or SMS client.

As noted, above, the ability of a user, having legitimate access to an organization's systems and electronic resources, to provide a third party with user credentials and/or system access allows users to subvert the organization's defined access and security policies. On the other hand, if stricter authentication challenges are put in place to avoid such improper usage (e.g., biometric challenges, dual factor authentication schemes, etc.), organizations and users may not be able to leverage provided services in an optimal manner.

Accordingly, aspects of the present disclosure are directed to providing secure delegated authority that is in line with a resource-providing organization's security policies and allows for controlled and monitored delegation of access to system resources. Aspects allow for highly secure authentication techniques in conjunction with controlled and secure delegation of resources and services, thereby providing high levels of infrastructure security, resource efficiency, and user satisfaction.

As indicated, above, an organization can provide an authentication platform and an interface through which users (e.g., customers) of the organization can access the authentication platform, authenticate themselves, and, once authenticated, make use of digital services and artifacts (digital resources) provided and managed by the organization. In accordance with aspects, an organization can provide its users with secure delegation techniques whereby a user can delegate some or all of the user's resource access to a third-party user.

In accordance with aspects, in addition to a user directory and an authentication platform, an organization can provide and maintain an access control platform, including an access control module that is configured to work in conjunction with the organization's authentication platform and its provided resources to broker access permissions to delegated users of the system.

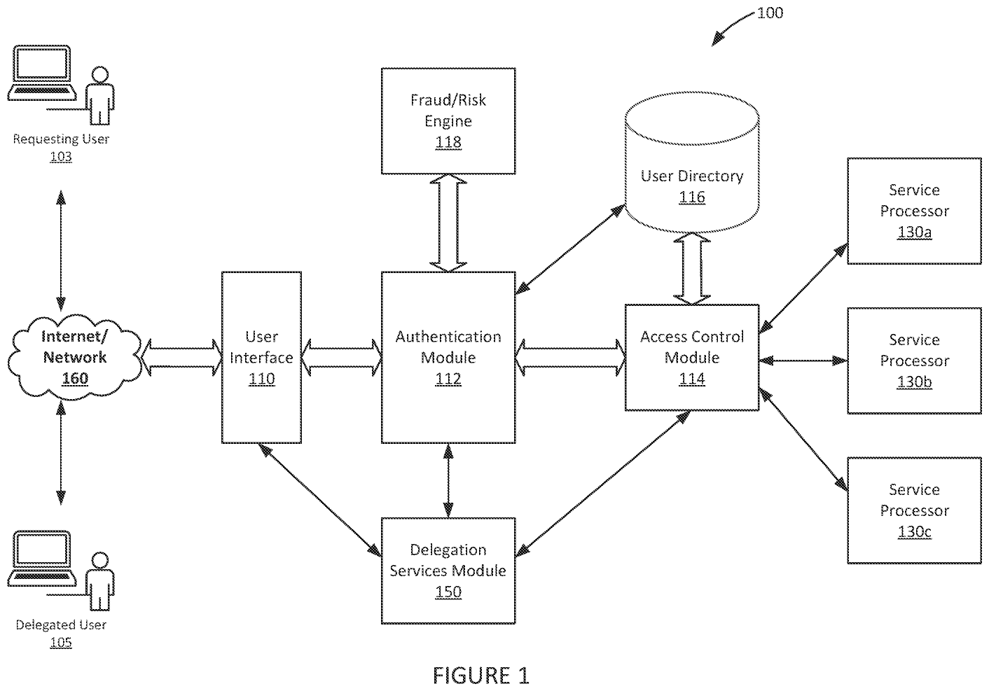

FIG. 1 is a block diagram of a system for providing secure delegated access to digital resources, in accordance with aspects. Referring to FIG. 1, system 100 represents components of an enterprise organization's technology infrastructure. The organization's infrastructure can include user directory 116 and authentication module 112. Authentication module 112 can be a part of a larger authentication platform. The infrastructure can further include user interface 110. User interface 110 provides an interface through which users can access and utilize an organization's provided resources.

System 100 further includes service processor 130a, service processor 130b, and service processor 130c. Service processors 130a-c represent digital resources available to authenticated users of system 100. Service processors 130a-c can be digital services, digital artifacts, or any combination thereof. As an example, in a scenario where system 100 is owned, controlled, maintained and/or provided by a financial institution, service processors 130a-c could include financial technology services such as bank account ledger applications, mobile payment application backend processors, bill payment backend processors, credit account ledger services, etc., etc. In a scenario where system 100 is owned, controlled, maintained and/or provided by a governmental institution, service processors 130a-c could include tax return filing service, vehicle registration services, student loan processing services, etc.

Particular details of the services and/or artifacts provided via service processors 130a-c will vary depending on the organization controlling and/or providing the services. While only three resources/services are depicted in FIG. 1, it is contemplated that an organization can provide as many digital resources to users as is necessary or desired by the organization.

In accordance with aspects, components of system 100 can also represent those of a device, or a device operating in conjunction with a remote system. For example, system 100 can represent an internet-of-things (IoT) enabled or capable device. The device may include some or all of the components depicted in FIG. 1. Components not housed on the IoT device may be housed in a remote location with which the IoT device is in operative communication. Examples of IoT devices abound. Many vehicles can be considered IoT devices in which certain or all components of system 100 can be present. Another example of IoT enabled devices includes consumer appliances such as refrigerators, ranges, dishwashers clothes washers, etc.

With continued reference to FIG. 1, requesting user 103 is a user of resources provided by system 100. Requesting user 103 has a user account that is stored in user directory 116. Requesting user 103 can access system 100 through user interface 110. Requesting user 103 can access user interface 110 through any suitable electronic user device that can be configured to access and operatively communicate with user interface 110. A user device may be configured to communicate with user interface 110 via internet/network 160. Internet/network 160 may be a public computer network, such as the Internet, or a private computer network, such as an organization's intranet. Communication may take place via any suitable communication protocol or combination of protocols (e.g., TCP/IP, HTTP, SOAP, ReST, etc.). User interface 110 may be a web page hosted by a webserver, an application server providing interface services to a mobile application, or any other suitable interface scheme that provides users of system 100 access to the services and resources provided therefrom.

Before accessing service processors 130a-c and the resources provided thereby, requesting user 103 can be prompted for authentication. That is, requesting user 103 can be prompted to provide user credentials via user interface 110. Authentication module 112 can use the provided user credentials to verify that a user account associated with the provided user identifier (e.g., a username, user identification number, etc.) exists in user directory 116. Authentication module 112 can then process the challenge information of the authenticated the user. Authentication module 112 can be configured for any suitable authentication scheme. For example, authentication module 112 can be configured for basic username/password authentication, for biometric authentication, for two (or more) factor authentication, etc. Advantageously, more secure authentication schemes can be used in conjunction with aspects of the disclosure, thereby enhancing the security of an implementing organization's technical systems and infrastructure.

As a part of the authentication scheme of system 100, fraud/risk engine 118 can be invoked and routines can be executed to predict the likelihood of fraudulent access to system 100. Fraud/risk engine 118 can include different schemes for fraud detection, such as machine learning models and other traditional algorithmic functions, that have been trained and/or developed to receive data related to an authentication request and predict the likelihood that the request did not originate with a legitimate user (e.g., requesting user 103). Many different factors can be considered, such as the geographic location the authentication request originated from, the device the authentication request originated from, etc. In accordance with aspects, fraud and risk detection routines can be used to infer the authenticity of a delegated user as part of an authentication scheme for delegated users.

Once fully authenticated to an organization's technology infrastructure, a user can utilize the provided resources which they are authorized to use. Authorization to the provided resources can be managed through an access control module 114. An access control module 114 can be configured to work in conjunction with a user directory in order to permit and/or restrict access to resources provided to authenticated users. Access control to electronic resources and artifacts can be based on mandatory access control (MAC) schemes, discretionary access control (DAC) schemes, role-based access control (RBAC), attribute-based access control (ABAC) (sometimes referred to as policy-based access control (PBAC)), or any other access control scheme that is suitable for a provided resource and that meets the providing organization's access control policies and procedures.

In an attribute-based access control scheme, access control is configured through the use of policies that execute Boolean logic using attributes that describe system objects as operands. Attributes can describe any system object. Exemplary system objects include user accounts, electronic artifacts such as files, applications, databases, actions, etc. Through the use of policies, logic, and attributes, ABAC allows fine-grained and contextually aware access control.

Referring again to FIG. 1, requesting user 103, once authenticated, can attempt to access a service or resource provided by one of service processors 130a-c. Access control module 114 can evaluate the attempted access and, based on configured permissions, can allow or deny the attempted access. Access control module 114 can be configured with any of the exemplary access control schemes discussed above, or any other suitable access control scheme.

In addition to personally using a providing organization's digital resources, an authenticated user may wish to delegate access to the digital resources to a delegated user. In accordance with aspects, a providing organization may provide a process by which an authenticated user can delegate, to a third-party, access/functionality the user has been granted to a digital resource.

With continued reference to FIG. 1, a providing organization may provide delegation services module 150 as a part of system 100. Delegation services module 150 can be in operative communication with other components of system 100, such as authentication module 112, access control module 114 and user interface 110. Delegation services module 150 can be configured to receive a request from requesting user 103 to delegate access to a provided digital resource, such as one of service processors 130a-c, to delegated user 105. The delegation request can include information about delegated user 105 and about the functionality that requesting user 103 wishes to delegate to delegated user 105.

In accordance with aspects, delegation services module 150 can, via user interface 110, provide a list of digital resources that requesting user 103 has access to and, for each digital resource in the list, can provide a corresponding sub-list of functionalities that may be delegated. For example, requesting user 103 can access system 100 via user interface 110. Upon access, system 100 can prompt requesting user 103 for authentication credentials, and system 100 can authenticate requesting user 103 as described, above. Once authenticated, user interface 110 may provide access to delegation services module 150. Delegation services module 150 may provide a list of delegable resources for requesting user 103 to choose from.

The list of delegable resources can be derived based on requesting user 103's resource access as maintained and provided by access control module 114. Delegation services module 150 can send a request to access control module 114 requesting a list of resources that requesting user 103 has permission to delegate. Access control module 114 can retrieve requesting user 103's stored permissions, and determine, based on the stored permissions, which resources requesting user 103 has been granted permission to delegate access to.

Requesting user 103's permissions may be stored in user directory 116 or in another suitable repository. Regardless of where the permissions are persisted, they can be associated with requesting user 103's user account such that access control module 114 can retrieve user 103's permissions to the digital resources provided by system 100. If access control module 114 is configured with an attribute-based access control scheme, then access control module 114 can execute permission policies associated with requesting user 103's user account to determine resources that requesting user 103 has been granted permission to delegate access to.

For example, in an ABAC scheme, access control module 114 can execute Boolean logic from access policy objects against attributes assigned to requesting user 103's user account, to the resources requesting user 103 has access to, and to any other relevant object having access attributes assigned to it. Exemplary logic could take the following form: IF requesting user 103 has access to service processor 130a, AND IF the access to service processor 130a incudes access to a particular delegable service provided by processor 130a, THEN requesting user 103 may delegate access to the particular delegable service provided by service processor 130a.

The logical flow, above, is exemplary and not meant to be limiting. In practice, ABAC policies can be based on many different attributes of many different objects. Any attribute can be used as an operand for evaluating a Boolean statement in an organization's permission policies. Accordingly, ABAC permission schemes can provide very fine-grained and contextually aware permissions to provided resources. System designers and developers can assign any attribute to a system resource that is necessary or desirable in order to produce resource permissions that are highly contextual. Attributes assigned to user account objects can be based on personal information about the user; e.g., the user's age, geographic location, etc. Resource attributes can be based on particular services offered, on data that will be accessed, etc.

In other aspects, an access control module can be based on an access control list, on role-based access control, or any other suitable access control scheme.

In accordance with aspects, a list of delegable resources can be provided to a requesting user, and the requesting user may select the resource (or resources) that the user intends to delegate access to. In the context of FIG. 1, delegation services module 150 can retrieve the list of delegable resources from access control module 114, and present the list to requesting user 103 via user interface 110. The list items may be formatted as user selectable items, such that requesting user 103 can select one or more of the list items from user interface 110.

Upon receiving a user selection of a delegable resource, a system can generate an identifier. The identifier can be a unique delegate identifier, and may take any suitable form. An exemplary delegate identifier is a random, arbitrary number (e.g., a decimal or hexadecimal number). The identifier can be used as a basis for generating delegated access for a delegated user. In accordance with aspects, the delegate identifier can be treated by an authentication and/or access control system as a system user. That is, the delegate identifier, although anonymous for at least a period of time, can be created as an object in, e.g., a user directory. Permissions can be assigned to, or based on, a delegate identifier. A delegate identifier can be related to the user account of the requesting user. A delegate identifier can have attributes assigned to it for evaluation in an ABAC scheme.

In accordance with aspects, delegation services can generate a delegate identifier, relate the delegate identifier to a user account of a requesting user, and assign permissions to the delegate identifier based on the requesting user's selection of a resource. For example, delegation services can assign a delegate identifier access permission, and lower-level permissions, to a resource selected for delegated access. The generated delegate identifier can be communicated to the delegated user, and the delegated user can use the delegate identifier to access and use a provided resource. For instance, a delegated user can provide the delegate identifier at a system interface, the system can authenticate the delegate identifier and then provide access to the resource associated with the delegate identifier that aligns with the permissions assigned to the delegate identifier.

Authenticating the delegate identifier can take any suitable form. In one aspect, authenticating the delegate identifier can include a check that the delegate identifier provided by a delegated user to the system interface matches a generated delegate identifier. In some aspects, a separate personal identification number (PIN) can be sent to a delegated user. The PIN can be sent in a communication that is separate from the communication by which the delegated user receives the delegate identifier. The delegated user may be required to supply both the delegate identifier and the PIN in order to authenticate the delegate identifier and gain access to the delegated digital resource. In some aspects, asymmetric encryption may be used to encrypt the delegate identifier. For instance, the organization that issues the delegate identifier may encrypt the identifier using the public encryption key, and the delegated user may decrypt the identifier with the private key before presenting the identifier to the issuer.

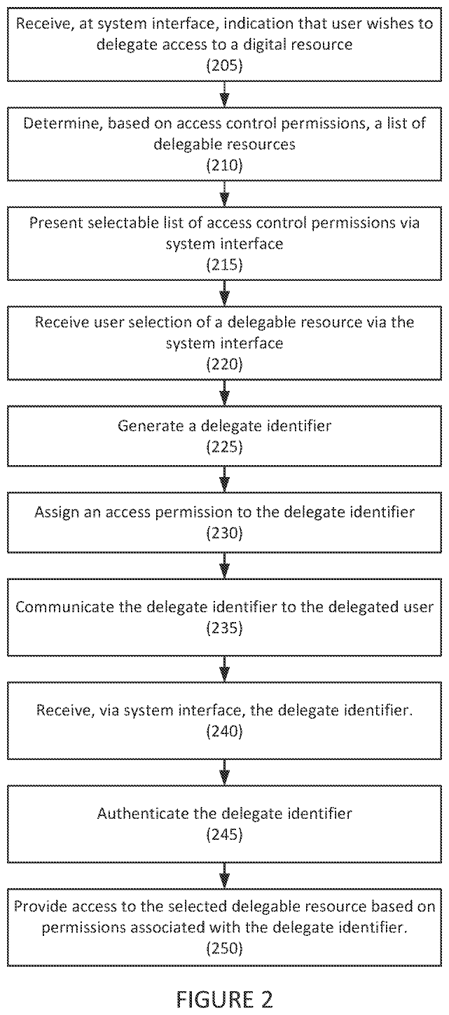

FIG. 2 is a logical flow for securely delegating access to digital resources, in accordance with aspects. At step 205, a requesting user that is authenticated to a providing organization's technology architecture can indicate, via a provided system interface, that the user wishes to delegate access to a digital resource offered by the system. At step 210, the system can determine, based on access control permissions, a list of delegable resources. At step 215, the system can provide, via the system interface, the list of delegable resources. The list can be formatted such that list items can be selected (e.g., vie check boxes, radio buttons, etc.).

At step 220, the system can receive a user-selection of at least one of the delegable resources from the list. At step 225, a delegate identifier can be generated by the system. The delegate identifier can be treated as a system user. In some aspects, the delegate identifier can be stored in a user directory and/or associated with the user account of the requesting user. At step 230, an access permission can be assigned to, or associated with, the delegate identifier by the system. The access permission can grant access to the delegable resource selected from the list by the requesting user.

At step 235, the delegate identifier can be communicated to the delegated user. The system may be configured to communicate the delegate identifier via an electronic channel. Alternatively, the system can be configured to provide the delegate identifier to, e.g., the requesting user, an employee of the resource-providing organization, an agent of the resource providing organization, etc. If provided to one of these exemplary persons, then that person can communicate the delegate identifier to the delegated user. At step 240, the system can receive, via a system interface, the delegate identifier. Having been communicated to the delegated user, the delegated user can access the system interface to provide the delegate identifier to the system. At step 245, the system can authenticate the delegate identifier. At step 250, the system can provide access to the selected delegable resource based on the associated access permission.

In accordance with embodiments, fraud services may be invoked to process information included in a delegation request and provide a prediction, or probability, that the request is fraudulent; for example, that a user account associated with the requesting user has been compromised and that the delegation request was initiated by a person other than the person associated with the requesting user account.

With reference to FIG. 1, delegation services module 150 can pass relevant information received with the request to authentication module 112 and authentication module 112 can, in turn pass the information to fraud/risk engine 118 for processing. In other aspect, delegation services module 150 may communicate directly with fraud/risk engine 118. In other aspects, a requesting user may be required to go through the authentication and fraud detection process, as described above, every time a new delegation request is received.

In accordance with aspects, the resource delegation process can be configured to receive information about a delegated user from a requesting user. The received information can include an electronic contact method of the delegated user. For example, a requesting user can provide an email address, a telephone number that can receive SMS messages, or some other electronic contact method by which the delegated user can receive electronic messages. A requesting user's selection of a delegable resource and information about a delegated user, including an electronic contact of the delegated user, can be received, and the received information can be used to generate a request to the delegated user. The request can include details about the resource that the delegated user is requested to access. The request can be sent to the delegated user via the received electronic contact information.

In one aspect, the delegate identifier can be sent to the delegated user embedded in a hyperlink. The hyperlink may point to a system interface that the delegated user can browse to using a browser application that is in operative communication with a computer network (e.g., the Internet). The delegated user's device may launch the browser application automatically when the hyperlink is activated. The delegate identifier may be embedded in the hyperlink as a parameter and may be passed to the system when the hyperlink is activated, without further need for the delegated user to know the delegate identifier, or manually input the delegate identifier into the system interface. Upon receiving the parameterized delegate identifier, the system may provide access to the delegable resource selected by the requesting user via the browser application.

Other methods of communicating a delegate identifier to a delegated user include providing a QR code that indicates the delegate identifier and can be scanned by the delegated user; providing a delegate identifier via NFC (e.g., from a requesting user's mobile electronic device); providing a printed delegate identifier; etc.

In accordance with aspects, a delegate identifier can be assigned use and time-based access permission. That is, a delegate identifier can be use-bound—configured to expire after a set number of uses or function executions of the associated delegated resource. For example, if the delegated resource is an on-line mortgage (or other bill) payment service, a delegate identifier can be assigned a use-bound permission that allows a delegated user to perform a single payment to be made. After the single payment is made, the delegate identifier can expire and a requesting user would have to make another delegation request in order to generate a new, unexpired delegate identifier. Likewise, a delegate identifier can be time-bound. That is, the delegate identifier may remain valid and able to access and perform a delegated function for a week, a month, a year, etc.

These and other applicable access policies can be set by default, and/or set by a requesting user at the time the delegation request is made. That is, a user interface to a delegation services module can include the ability for a requesting user to provide/change access policies associated with a delegate identifier.

In accordance with aspects, a delegated user may be required to setup a user account in order to gain access to the delegated resource. A delegated user may access a system interface and provide the delegate identifier to the interface, at which point delegation services may direct the interface to interact with authentication services and/or a user directory. The delegated user can provide user account details (e.g., a username, password, personal information, etc.) and delegate access permissions can be assigned to the delegated user's user account. In aspects, the delegated user can then use the created user account and user credentials for delegated system access in subsequent delegation requests.

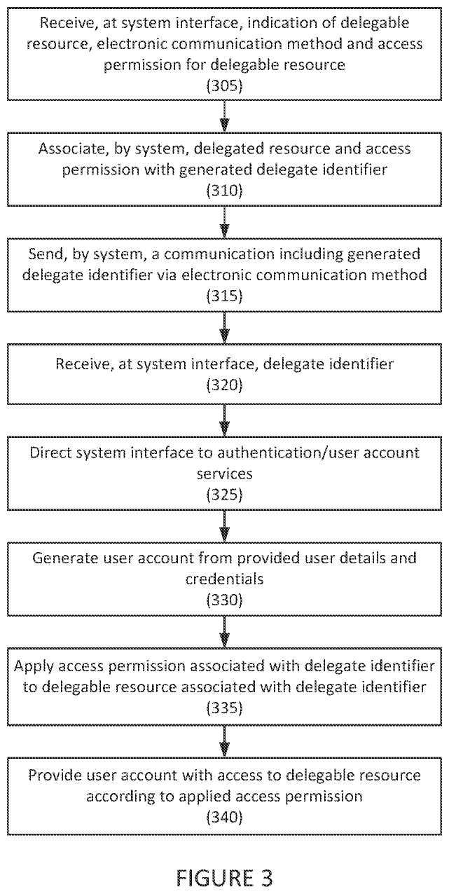

FIG. 3 is a logical flow for delegating access to a resource, in accordance with embodiments. At step 305, a requesting use can interact with a system interface that provides the ability for the requesting user to select a delegable resource, specify an electronic communication method, and set an access permission for the delegated user. At step 310, the delegated resource and the specified (and/or default) access permissions can be associated with the generated delegate identifier. At step 315, delegation services can send a communication including the delegate identifier to the delegated user via the specified communication method. At step 320, the delegated user can access a system interface and provide the delegate identifier for authentication by the system, and the system can receive the delegate identifier. The delegated user can provide the delegate identifier by any suitable method (e.g., any method discussed above).

At step 325, the system can direct the system interface to interact with authentication services and/or a user directory. At step 330, the system prompts the delegated user to set up a user account and provide user credentials, and the delegated user proceeds to setup the user account. At step 335, the system applies the access permission(s) associated with the delegate identifier to the newly created user account, and at step 340, the system provides access according the assigned permissions to the newly created user account.

As noted above system components for carrying out aspects described herein (e.g., components described with reference to FIG. 1) can be integrated, fully or partially, into a device (e.g., an IoT device). In aspects where some components are not integrated into a device, these components can be housed and operated in a remote location, such as a data center, or in a cloud computing environment. In these aspects, the device can communicate with the remotely housed components via a computer network, such as the internet.

In one aspect, some or all system components described herein, including logical functionality that executes on hardware components, can be included in a vehicle. For example, a user interface can take the form of a screen (e.g., a touch screen) positioned on a dashboard or a console of a vehicle. A digital resource, in the context of a vehicle may be driving privileges for the vehicle. That is, a requesting user may, via an interface such as a touch screen, indicate that a delegated user receives delegated access to operate the vehicle.

Permissions to the digital resource (in this example, vehicle operation) can be assigned, as described above. For instance, access to operate the vehicle may be assigned on a use-bound, time-bound, or other restrictive basis. An exemplary scenario is a delegated user's permission to an operation resource being restricted to daylight hours and/or being restricted to a particular timeframe, such as a specified week or month. Further, certain digital resources of the vehicle may be restricted. For instance, an entertainment resource (e.g., a radio, media player, etc.) may not be granted delegate access, while the operation resource is.

In the context of FIG. 1, interface 110 can be representative of a vehicle's touch screen interface. Service processor 130a can represent a basic vehicle operation resource. Service processor 130b may represent a vehicle's entertainment resource, and so on. Authentication module 112 may be present onboard the vehicle, and may include, e.g., a biometric authentication scheme (e.g., a fingerprint scan to activate provided digital resources). User directory 116 may be housed and operated offline, or may be onboard the vehicle system, but may be replicated to a remote system for redundancy.

Likewise, aspects can be deployed in a similar manner an IoT appliance such as a refrigerator, a clothes washer, a smart thermostat, etc.

The various processing steps and/or data flows depicted in the figures and described in greater detail herein may be accomplished using some or all of the system components also described herein. In some implementations, the described logical steps may be performed in different sequences and various steps may be omitted. Additional steps may be performed along with some or all of the steps shown in the depicted logical flow diagrams. Some steps may be performed simultaneously. Accordingly, the logical flows illustrated in the figures and described in greater detail herein are meant be exemplary and, as such, should not be viewed as limiting. These logical flows may be implemented in the form of executable instructions stored on a machine-readable storage medium and/or in the form of electronic circuitry.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A system for providing secure delegated access to a digital resource, comprising:
an authentication module;
a user directory;
as access control module;
a delegation services module; and
a user interface;
wherein the delegation services module is configured to:
receive, from the user interface, a delegation request, and wherein the delegation request is associated with a user account stored in the user directory;
invoke the access control module to determine a list of delegable resources for which the user account has permission to delegate access;
present the list of delegable resources via a user interface;
receive from the user interface, a user selection of a delegable resource from the list; and
generate a delegate identifier;
wherein the access control module is configured to associate an access permission to the delegate identifier, wherein the access permission provides access to the delegable resource;
wherein the authentication module is configured to
receive the delegate identifier via the user interface; and
authenticate the delegate identifier; and
wherein the access control module is further configured to provide access to the delegable resource based on the access permission.

2. The system of claim 1, wherein the delegation request includes the access permission.

3. The system of claim 1, wherein the access permission is a default permission.

4. The system of claim 1, wherein the delegation request incudes an electronic communication method.

5. The system of claim 4, wherein the delegation services module is further configured to send a communication via the electronic communication method, and wherein the communication includes the delegate identifier.

6. The system of claim 1, wherein the access permission is a use-bound permission.

7. The system of claim 1, wherein the access permission is a time-bound permission.

8. The system of claim 1, wherein the access control module employs an attribute-based access control scheme.

9. The system of claim 1, wherein the delegable resource is a vehicle operation resource.

10. The system of claim 9, wherein the user interface is included as a physical interface of the vehicle.

11. A method of providing secure delegated access to a digital resource, comprising:
receiving a delegation request, wherein the delegation request is associated with a user account;
determining a list of delegable resources for which the user account has permission to delegate access;
presenting the list of delegable resources via a user interface;
receiving from the user interface, a user selection of a delegable resource from the list;
generating a delegate identifier;
associating an access permission to the delegate identifier, wherein the access permission provides access to the delegable resource;
receiving the delegate identifier via the user interface;
authenticating the delegate identifier; and
providing access to the delegable resource based on the access permission.

12. The method of claim 11, wherein the delegation request includes the access permission.

13. The method of claim 11, wherein the access permission is a default permission.

14. The method of claim 11, wherein the delegation request incudes an electronic communication method.

15. The method of claim 14, comprising:
sending a communication via the electronic communication method, and wherein the communication includes the delegate identifier.

16. The method of claim 11, wherein the access permission is a use-bound permission.

17. The method of claim 11, wherein the access permission is a time-bound permission.

18. The method of claim 11, comprising:
employing an attribute-based access control scheme.

19. The method of claim 11, wherein the delegable resource is a vehicle operation resource.

20. A non-transitory computer readable storage medium, including instructions stored thereon for providing secure delegated access to a digital resource, which when read and executed by one or more computers cause the one or more computers to perform steps comprising:
receiving a delegation request, wherein the delegation request is associated with a user account;
determining a list of delegable resources for which the user account has permission to delegate access;
presenting the list of delegable resources via a user interface;
receiving from the user interface, a user selection of a delegable resource from the list;
generating a delegate identifier;
associating an access permission to the delegate identifier, wherein the access permission provides access to the delegable resource;
receiving the delegate identifier via the user interface;
authenticating the delegate identifier; and
providing access to the delegable resource based on the access permission.
